(19) United States
(12) Patent Application Publication
(10) Pub. No.: US 2026/0141675 A1
(43) Pub. Date: May 21, 2026

(54) METHOD AND DEVICE FOR DETERMINING ADAPTIVE BRIGHTNESS FOR IMAGE CONTAINING ANIMAL

(71) Applicant: PETNOW INC., Seoul (KR)

(72) Inventors: Joon Ho LIM, Goyang-si (KR); Dae Hyun PAK, Seoul (KR)

(73) Assignee: PETNOW INC., Seoul (KR)

(21) Appl. No.: 19/393,647

(22) Filed: Nov. 19, 2025

(30) Foreign Application Priority Data
Nov. 21, 2024 (KR) 10-2024-0167059

(51) Int. Cl. G06V 10/60; G06V 40/10

(52) U.S. Cl. CPC G06V 10/60; G06V 40/103

(57) ABSTRACT

Proposed are a method and a device for determining adaptive brightness for an image containing an animal. The method may include acquiring a first image containing the animal, identifying a first region corresponding to the animal in an entire region of the first image, calculating a first brightness value in the first region, and calculating the adaptive brightness of the first image on the basis of the first brightness value.

### CROSS REFERENCE TO RELATED APPLICATION

The present application claims priority to Korean Patent Application No. 10-2024-0167059, filed Nov. 21, 2024, the entire contents of which are incorporated herein for all purposes by this reference.

### BACKGROUND

### Technical Field

The present disclosure relates to a technology of image processing. More particularly, the present disclosure relates to a method and a device for determining adaptive brightness for an image containing an animal.

### Description of the Related Art

Generally, in an automatic brightness correction algorithm of a camera, an exposure time and a sensitivity value (an ISO value) of a sensor are determined on the basis of an average brightness value of an entire input image, so that a photograph with an appropriate brightness is captured. In a situation in which a cellular phone acquires biometric information of a companion animal, when a dog or a cat having black fur is captured in an image, a conventional automatic brightness correction algorithm may determine that an average brightness is dark and may excessively adjust an exposure time and a sensitivity value of a sensor, so that there is a problem that low-quality biometric information that is blurred or severely noisy is acquired.

### SUMMARY

Accordingly, the present disclosure has been made keeping in mind the above problems occurring in the related art, and an objective of the present disclosure is to provide a method and a device for determining adaptive brightness for an image containing an animal.

In order to achieve the above objective, according to an aspect of the present disclosure, there is provided a method for determining adaptive brightness for an image containing an animal, the method being performed in a computing device. The method may include: acquiring a first image containing the animal; identifying a first region corresponding to the animal in an entire region of the first image; calculating a first brightness value in the first region; and calculating the adaptive brightness of the first image on the basis of the first brightness value.

According to an aspect of the present disclosure, the method may further include calculating a second brightness value in a second region that is an area excluding the first region from the entire region after the calculating of the first brightness value. Furthermore, the calculating of the adaptive brightness of the first image may include calculating the adaptive brightness of the first image on the basis of the first brightness value and the second brightness value.

According to an aspect of the present disclosure, the calculating of the adaptive brightness of the first image on the basis of the first brightness value and the second brightness value may include: calculating a first corrected brightness value by applying a first weight to the first brightness value when the first brightness value is larger than the second brightness value; calculating a second corrected brightness value by applying a second weight to the second brightness value; and calculating the adaptive brightness of the first image on the basis of the first corrected brightness value and the second corrected brightness value.

According to an aspect of the present disclosure, the first weight and the second weight may be predetermined according to at least one of a type, a breed, and a fur color of the animal.

According to an aspect of the present disclosure, the calculating of the adaptive brightness of the first image on the basis of the first corrected brightness value and the second corrected brightness value may include determining an average value of the first corrected brightness value and the second corrected brightness value as the adaptive brightness of the first image.

According to an aspect of the present disclosure, the calculating of the adaptive brightness of the first image on the basis of the first brightness value and the second brightness value may include: calculating a third corrected brightness value by applying a third weight to the first brightness value when the first brightness value is smaller than the second brightness value; and calculating the adaptive brightness of the first image on the basis of the third corrected brightness value.

According to an aspect of the present disclosure, the third weight may be determined on the basis of information of a camera capturing the first image.

According to an aspect of the present disclosure, the calculating of the first brightness value in the first region may include: dividing the first region into a plurality of sub-regions having a predetermined number; and determining an average value of brightness values acquired from each of the plurality of sub-regions as the first brightness value.

According to an aspect of the present disclosure, the identifying of the first region may include identifying the first region corresponding to the animal in the entire region of the first image by using a pre-trained artificial intelligence-based animal detection model.

According to an aspect of the present disclosure, the animal detection model may be pre-trained by using a training image containing at least one animal and training data including a region of the at least one animal corresponding to the training image.

According to an aspect of the present disclosure, the method may further comprise: generating a second image by applying the adaptive brightness to the first image; identifying a third region corresponding to the animal in an entire region of the second image; and determining the third region as biometric information of the animal.

According to an aspect of the present disclosure, the calculating of the adaptive brightness of the first image may include calculating the adaptive brightness of the first image on the basis of the first brightness value and at least one piece of information about a type, a breed, and a fur color of the animal.

According to another aspect of the present disclosure, there is provided a computing device for determining adaptive brightness for an image containing an animal. The computing device may include at least one processor and a memory configured to store instructions executable by the at least one processor. The at least one processor may be configured to: acquire a first image containing the animal; identify a first region corresponding to the animal in an entire region of the first image; calculate a first brightness value in the first region; and calculate the adaptive brightness of the first image on the basis of the first brightness value.

According to the present disclosure, in the process of acquiring a biometric information image of a companion animal, a region of an animal and a background region may be distinguished from each other, and the brightness of the image may be determined adaptively according to brightness information of each region.

The effect that can be obtained from the present disclosure are not limited to the above-mentioned effect, and other effects not mentioned herein will be clearly understood by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an exemplary view illustrating a computing device for determining adaptive brightness for an image containing an animal according to an embodiment of the present disclosure;

FIG. 2 to FIG. 7 are flowcharts illustrating a method for determining adaptive brightness for an image containing an animal according to an embodiment of the present disclosure; and

FIG. 8 is a view illustrating a process of determining adaptive brightness for an image containing an animal according to an embodiment of the present disclosure.

### DETAILED DESCRIPTION

Various exemplary embodiments will now be described with reference to drawings. In the present specification, various descriptions are presented to provide an understanding of the present disclosure. However, it is apparent that the exemplary embodiments may be executed without the specific description.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Furthermore, it should be understood that the term “and/or” used in this specification designates and includes all available combinations of at least one item among enumerated related items.

It should be appreciated that the term “include” and/or “including” means presence of corresponding features and/or components. However, it should be appreciated that the term “include” and/or “including” means that presence or addition of one or more other features, components, and/or a group thereof is not excluded.

Furthermore, when not separately specified or it is not clear in terms of the context that a singular form is indicated, it should be construed that the singular form generally means “one or more” in this specification and the claims.

In the present disclosure, terms expressed by a “N-th” such as first, second, or third are used to distinguish a plurality of entities. For example, entities expressed with a first and a second may be identical or different.

In the present disclosure, a risk may be any potential risk that can occur as a model replaces human judgment during development or operation of a service using the model. In an embodiment, the risk may refer to any risk other than a pre-existing risk that has already occurred or exists due to conventional business procedures, information protection, or security. In an embodiment, the risk may be determined on the basis of a core value for risk management of the model in consideration of the characteristics of each industry. For example, in the financial industry, the risk may be determined on the basis of property rights, equality, or transparency among the basic rights of customers. In an embodiment, the risk may be an expected residual risk remaining after establishing control measures for detailed risks identified in a service using the model.

Throughout the present specification, the model and an artificial intelligence-based model (for example, an animal detection model) may be used as the same meaning. The artificial intelligence-based model may be formed of an aggregate of calculation units which are mutually connected to each other and which may be called nodes. Such nodes may also be referred to as neurons. The artificial intelligence-based model includes at least one node. The nodes (alternatively, neurons) constituting the artificial intelligence-based model may be connected to each other by at least one link.

In the artificial intelligence-based model, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated on the basis of the link. At least one output node may be connected to one input node through the link and vice versa.

In the relationship of the input node and the output node connected through one link, a value of data of the output node may be determined on the basis of data input in the input node. Here, the link connecting the input node and the output node to each other may have a weight. The weight may be variable, and the weight is variable by a user or an algorithm in order for the artificial intelligence-based model to perform a desired function. For example, when one or more input nodes are mutually connected to one output node by the respective links, the output node may determine an output node value on the basis of values input in the input nodes connected with the output node and the weights set in the links corresponding to the respective input nodes.

The artificial intelligence-based model may include a Convolutional Neural Network (CNN), a Recurrent Neural Network (RNN), an auto encoder, Generative Adversarial Networks (GAN), and so on.

The artificial intelligence-based model may be trained in at least one scheme of supervised learning, unsupervised learning, semi supervised learning, or reinforcement learning. The learning of the artificial intelligence-based model may be a process of applying knowledge for performing a specific operation to the model.

The artificial intelligence-based model may be trained in a direction to minimize errors of an output. The training of the model is a process of repeatedly inputting training data into the model and calculating the output of the model for the training data and the error of a target and back-propagating the errors of the model from the output layer of the model toward the input layer in a direction to reduce the errors to update the weight of each node of the model. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which a category is labeled in each training data. The labeled training data is input to the artificial intelligence-based model, and the error may be calculated by comparing the output (category) of the artificial intelligence-based model with the label of the training data. As another example, in the case of the unsupervised learning related to the data classification, the training data as the input is compared with the output of the artificial intelligence-based model to calculate the error. The calculated error is back-propagated in a reverse direction (i.e., a direction from the output layer toward the input layer) in the artificial intelligence-based model and connection weights of respective nodes of each layer of the artificial intelligence-based model may be updated according to the back propagation. A variation amount of the updated connection weight of each node may be determined according to a learning rate. Calculation of the artificial intelligence-based model for the input data and the back propagation of the error may constitute a training cycle (epoch). The learning rate may be applied differently according to the number of repetition times of the training cycle of the artificial intelligence-based model. For example, in an initial stage of the training of the artificial intelligence-based model, the artificial intelligence-based model ensures a certain level of performance quickly by using a high learning rate, thereby increasing efficiency. Furthermore, the artificial intelligence-based model uses a low learning rate in a latter stage of the training, thereby increasing accuracy.

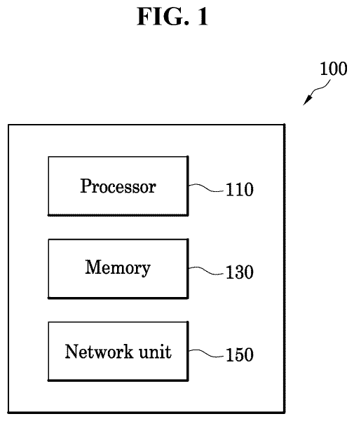

FIG. 1 is an exemplary view illustrating a computing device for determining adaptive brightness for an image containing an animal according to an embodiment of the present disclosure.

A computing device 100 may include at least one processor 110, a memory 130, and a network unit 150.

The processor 110 may be formed of at least one core. The processor 110 may control overall operations of the computing device 100. As the processor 110 reads a computer program stored in the memory 130, the processor 110 may determine adaptive brightness for an image containing an animal according to an embodiment of the present disclosure.

The memory 130 may store information generated or determined by the processor 110 and information received through the network unit 150. The memory 130 may be implemented as one storage medium of a flash memory type, a hard disk type, a multimedia card micro type, a card type memory (such as an SD memory or an XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, or an optical disk.

The network unit 150 may include any wired or wireless communication network capable of transmitting and receiving any type of data, information, and a signal. The network unit 150 may communicate with an external device. The external device may be, for example, a server or a user device that receives a degree of risk about an artificial-intelligence-based model.

In the present disclosure, a computer (for example, the computing device 100) generally includes various computer-readable media. Any media accessible by a computer may be a computer-readable medium. Such a computer-readable medium includes a volatile medium, a non-volatile medium, a transitory medium, a non-transitory medium, a removable medium, and a non-removable medium. As a non-limiting example, the computer-readable medium may include a computer-readable storage medium. The computer-readable storage medium includes a volatile medium, a non-volatile medium, a transitory medium, a non-transitory medium, a removable medium, and a non-removable medium that are implemented by any method or technology for storing information, such as a computer readable instruction, a data structure, a program module, or other data. The computer-readable storage medium may include a RAM, a ROM, an EEPROM, a flash memory, or other memory technology; a CD-ROM, a DVD (digital video disk), or other optical disk storage device; a magnetic cassette, a magnetic tape, or a magnetic disk storage device; or any other medium accessible by a computer and usable to store desired information, but the present disclosure is not limited thereto.

Next, according to an embodiment of the present disclosure, a detailed process, by the processor 110, for determining adaptive brightness for an image containing an animal will be described below.

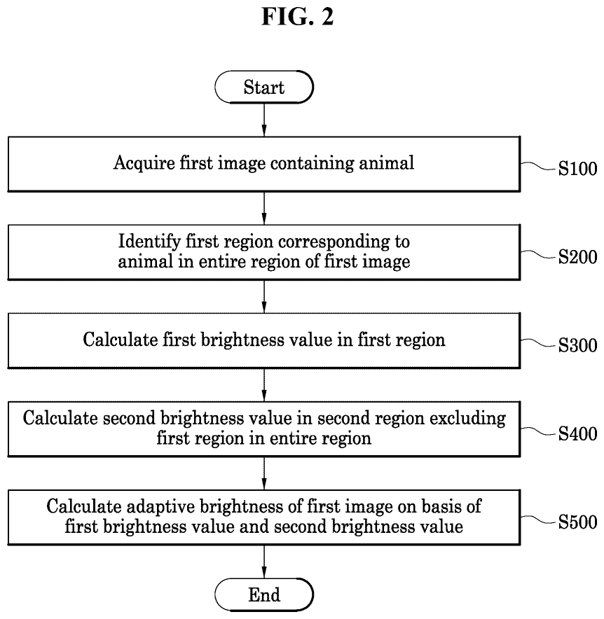

FIG. 2 to FIG. 7 are flowcharts illustrating a method for determining adaptive brightness for an image containing an animal according to an embodiment of the present disclosure. Processes shown in FIG. 2 to FIG. 7 are exemplary processes. Accordingly, it will be apparent to those skilled in the art that some processes in the processes shown in FIG. 2 to FIG. 7 may be omitted or additional processes may be added without departing from the scope of the present disclosure. For example, the processes in the flowcharts illustrated in FIG. 2 to FIG. 7 may be executed by the computing device 100.

Referring to FIG. 2, the processor 110 of the computing device 100 may acquire a first image containing an animal S100. In one embodiment, the animal may be a multicellular and eukaryotic living organism classified as a biological taxon distinguished from plants. The animal may include a companion animal such as a cat, a dog, and a bird.

For example, the processor 110 may acquire the first image containing the animal by capturing the animal through a capturing unit (for example, a camera) of the computing device 100.

Alternatively, for example, the processor 110 may acquire the first image containing the animal from images pre-stored in the memory 130.

As another example, the processor 110 may receive the first image containing the animal from the external device (for example, the server, the user terminal, and so on) different from the computing device 100.

The processor 110 may identify a first region corresponding to the animal in an entire region of the first image S200.

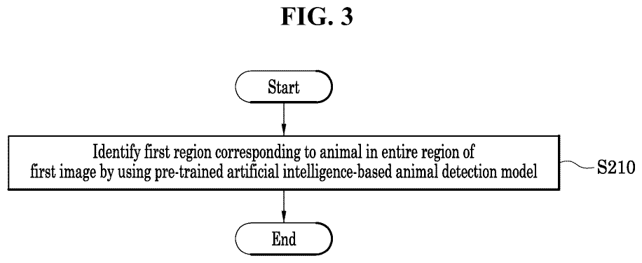

In an embodiment, referring to FIG. 3, the processor 110 may identify the first region corresponding to the animal in the entire region of the first image by using a pre-trained artificial intelligence-based animal detection model S210.

In an embodiment, the animal detection model may be pre-trained by using a training image in which at least one animal is contained and training data including a region of the at least one animal, the region corresponding to the training image. In an embodiment, the processor 110 may detect a type and a position of the animal by using information (for example, position information, identification information, classification information, and so on of the animal) about the animal output from the animal detection model into which the image is input.

In some embodiments, when information about the animal is mapped to the first image, the processor 110 may identify the first region corresponding to the animal in the entire region of the first image by using a first animal detection model trained with a training dataset corresponding to the animal mapped to the first image among a plurality of animal detection models on the basis of information about the animal mapped to the first image.

In some embodiments, the first animal detection model may be pre-trained by using a first training image in which the animal mapped to the first image is contained and training data including a region of the animal corresponding to the first training image. As the computing device 100 uses the animal detection model corresponding to each animal, the computing device 100 may achieve higher accuracy than an accuracy acquired when an animal detection model that is universally used is used. In addition, since the computing device 100 uses different training data for each animal detection model, a training amount and a training time may be reduced compared to an animal detection model trained for all animals.

Referring to FIG. 2 again, the processor 110 may calculate a first brightness value in the first region S300.

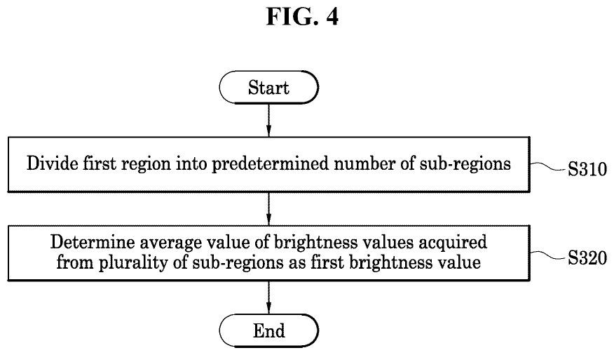

Referring to FIG. 4, the processor 110 may divide the first region into a predetermined number of sub-regions S310. For example, the processor 110 may divide the first region into nine sub-regions.

In some embodiments, the processor 110 may divide the first region into a predetermined number of sub-regions according to the type and the breed of the animal. For example, when the animal is a dog and the breed of the dog is Shih Tzu, the processor 110 may divide the first region into ten sub-regions. The number of sub-regions formed by dividing the first region may vary according to the type and the breed of the animal. For example, when the animal has different colors in different regions within the face or the body and the face of the animal have colors different from each other, a detailed analysis is required, so that the processor 110 may increase the number of sub-regions beyond a reference count (for example, five). In another example, when the animal has similar colors across regions, the processor 110 may reduce the number of sub-regions below the reference count.

In some embodiments of the present disclosure, when classification of the animal by the animal detection model is a multiple classification (for example, a deer with 30%, a horse with 30%, and a roe deer with 40%), the first region may be divided into a plurality of sub-regions according to the reference count.

The processor 110 may determine an average brightness value of brightness values obtained from the plurality of sub-regions as the first brightness value S320. In an embodiment, the processor 110 may determine the minimum brightness value (or the maximum brightness value) among the brightness values obtained from the plurality of sub-regions as the first brightness value.

Referring to FIG. 2 again, the processor 110 may calculate a second brightness value in a second region excluding the first region from the entire region S400. For example, the processor 110 may divide the second region into a predetermined number of sub-regions. The processor 110 may determine any one of an average brightness value, the minimum brightness value, or the maximum brightness value of the brightness values obtained from the plurality of sub-regions as the second brightness value.

The processor 110 may calculate adaptive brightness of the first image on the basis of the first brightness value and the second brightness value S500.

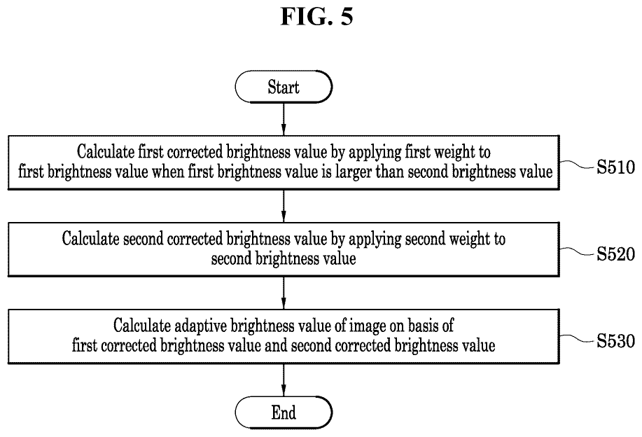

For example, referring to FIG. 5, when the first brightness value is larger than the second brightness value, the processor 110 may calculate a first corrected brightness value by applying a first weight to the first brightness value S510.

The processor 110 may calculate a second corrected brightness value by applying a second weight to the second brightness value S520.

In an embodiment, the first weight and the second weight may be predetermined according to the type, the breed, and the fur color of the animal. For example, when a color of the animal is dark, the processor 110 may set a first weight higher than a second weight. In another example, when a color of the animal is light, the processor 110 may set the first weight lower than the second weight.

The processor 110 may calculate the adaptive brightness of the image on the basis of the first corrected brightness value and the second corrected brightness value S530.

In an embodiment, the processor 110 may determine an average value of the first corrected brightness value and the second corrected brightness value as the adaptive brightness of the image.

In another example, the processor 110 may determine the adaptive brightness by considering only a region in which the animal exists and not additionally considering a region in which the animal does not exist. In an embodiment, the processor 110 may acquire the first image containing the animal. The processor 110 may identify the first region corresponding to the animal in the entire region of the first image. The processor 110 may calculate the adaptive brightness of the first image on the basis of the first brightness value of the first region.

Specifically, the processor 110 may calculate the adaptive brightness of the first image on the basis of the first brightness value and at least one piece of information about the type, the breed, and the fur color of the animal. For example, the processor 110 may calculate the adaptive brightness of the first image by multiplying the first brightness value by a predetermined coefficient (for example, 1.1, 0.9, and so on) according to at least one piece of information about the type, the breed, and the fur color of the animal. In another example, the processor 110 may calculate the adaptive brightness of the first image by multiplying the first brightness value by the predetermined coefficient (for example, 1.1, 0.9, and so on) according to a combination of the type, the breed, and the fur color of the animal. For example, for a combination (dog, Doberman, black), the predetermined coefficient may be 0.9. In another example, for a combination (cat, Persian, white), the predetermined coefficient may be 1.1.

In addition, the processor 110 may divide the first region into the predetermined number of sub-regions. The processor 110 may determine an average value of the brightness values obtained from the respective sub-regions as the first brightness value.

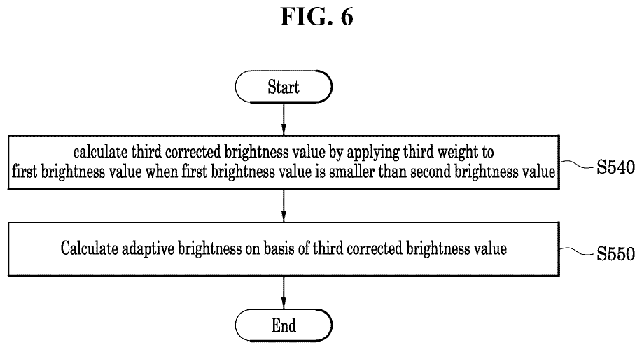

Specifically, referring to FIG. 6, when the first brightness value is smaller than the second brightness value, the processor 110 may calculate a third corrected brightness value by applying a third weight to the first brightness value S540. The fact that the first brightness value is smaller than the second brightness value may indicate that the first region corresponding to the animal is darker than other regions, and thus it may be necessary to adjust the brightness value on the basis of the first region.

In an embodiment, the third weight may be determined on the basis of information of the camera capturing the first image. In an embodiment, the information about the camera may include lens information, sensor information (for example, the exposure time, the sensitivity value, and so on of the sensor).

The processor 110 may calculate the adaptive brightness of the image on the basis of the third corrected brightness value S550.

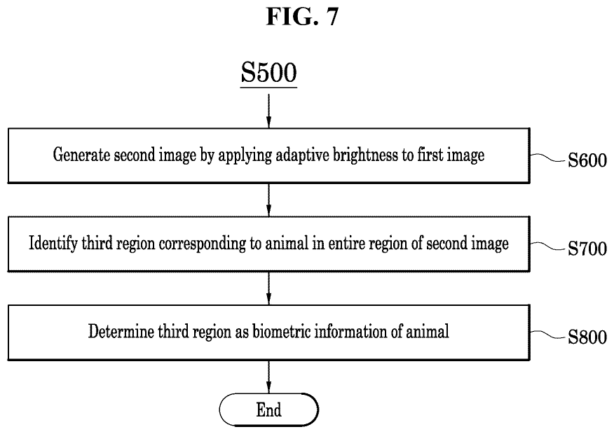

In an embodiment, referring to FIG. 7, the processor 110 may generate a second image by applying the adaptive brightness to the first image S600. For example, the processor 110 may generate the second image by converting the brightness of the first image to the adaptive brightness.

The processor 110 may identify a third region corresponding to the animal in an entire region of the second image S700. For example, by using the pre-trained artificial intelligence-based animal detection model, the processor 110 may identify the third region corresponding to the animal in the entire region of the second image.

The processor 110 may determine the third region as biometric information of the animal S800. For example, the processor 110 may determine a structure and a color of the animal, the fur color and a color pattern of the animal, a body shape of the animal, a size of the animal, and so on of the animal existing in the third region as the biometric information of the animal.

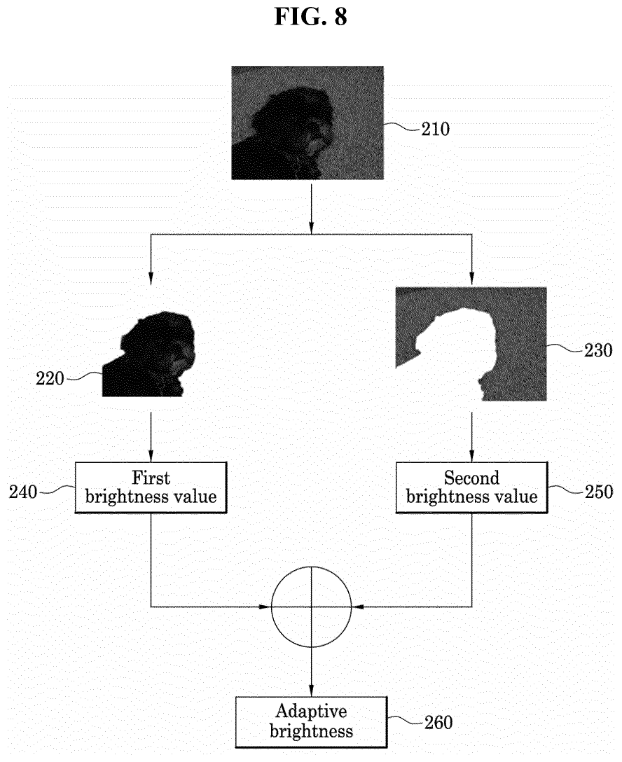

FIG. 8 is a view illustrating a process of determining adaptive brightness for an image containing an animal according to an embodiment of the present disclosure. Among the configurations described later with reference to FIG. 8, contents already described may be omitted. A detailed description of the configurations to be described later with reference to FIG. 8 may be replaced by the descriptions given above with reference to FIG. 1 to FIG. 7.

Referring to FIG. 8, the processor 110 may acquire a first image 210 containing an animal.

The processor 110 may identify a first region 220 corresponding to the animal in an entire region of the first image 210. For example, as the processor 110 uses the pre-trained artificial intelligence-based animal detection model, the processor 110 may identify the first region 220 corresponding to the animal in the entire region of the first image 210.

The processor 110 may calculate a first brightness value 240 in the first region 220.

The processor 110 may calculate a second brightness value 250 in a second region 230 excluding the first region 220 from the entire region of the first image 210.

The processor 110 may calculate the adaptive brightness 260 of the first image 210 on the basis of the first brightness value 240 and the second brightness value 250.

The description about the embodiments is provided so as for those skilled in the art to use or carry out the present disclosure. Various modifications of the embodiments will be apparent to those skilled in the art. General principles defined herein may be applied to other embodiments without departing from the scope of the present disclosure. Therefore, the present disclosure is not limited to the embodiments presented herein. The present disclosure shall be interpreted within the broadest meaning range consistent to the principles and new characteristics presented herein.

What is claimed is:

1. A method performed by a computing device and performed for determining adaptive brightness for an image containing an animal, the method comprising:
acquiring a first image containing the animal;
identifying a first region corresponding to the animal in an entire region of the first image;
calculating a first brightness value in the first region; and
calculating the adaptive brightness of the first image on the basis of the first brightness value.

2. The method of claim 1, further comprising:
calculating a second brightness value in a second region that is an area excluding the first region from the entire region after the calculating of the first brightness value;
wherein the calculating of the adaptive brightness of the first image comprises:
calculating the adaptive brightness of the first image on the basis of the first brightness value and the second brightness value.

3. The method of claim 2, wherein the calculating of the adaptive brightness of the first image on the basis of the first brightness value and the second brightness value comprises:
calculating a first corrected brightness value by applying a first weight to the first brightness value when the first brightness value is larger than the second brightness value;
calculating a second corrected brightness value by applying a second weight to the second brightness value; and
calculating the adaptive brightness of the first image on the basis of the first corrected brightness value and the second corrected brightness value.

4. The method of claim 3, wherein the first weight and the second weight are predetermined according to at least one of a type, a breed, and a fur color of the animal.

5. The method of claim 3, wherein the calculating of the adaptive brightness of the first image on the basis of the first corrected brightness value and the second corrected brightness value comprises determining an average value of the first corrected brightness value and the second corrected brightness value as the adaptive brightness of the first image.

6. The method of claim 3, wherein the calculating of the adaptive brightness of the first image on the basis of the first brightness value and the second brightness value comprises:
calculating a third corrected brightness value by applying a third weight to the first brightness value when the first brightness value is smaller than the second brightness value; and
calculating the adaptive brightness of the first image on the basis of the third corrected brightness value.

7. The method of claim 6, wherein the third weight is determined on the basis of information of a camera capturing the first image.

8. The method of claim 1, wherein the calculating of the first brightness value in the first region comprises:
dividing the first region into a plurality of sub-regions having a predetermined number; and
determining an average value of brightness values acquired from each of the plurality of sub-regions as the first brightness value.

9. The method of claim 1, wherein the identifying of the first region comprises identifying the first region corresponding to the animal in the entire region of the first image by using a pre-trained artificial intelligence-based animal detection model.

10. The method of claim 9, wherein the animal detection model is pre-trained by using a training image containing at least one animal and training data including a region of the at least one animal corresponding to the training image.

11. The method of claim 1, further comprising:
generating a second image by applying the adaptive brightness to the first image;
identifying a third region corresponding to the animal in an entire region of the second image; and
determining the third region as biometric information of the animal.

12. The method of claim 1, wherein the calculating of the adaptive brightness of the first image comprises calculating the adaptive brightness of the first image on the basis of the first brightness value and at least one piece of information about a type, a breed, and a fur color of the animal.

13. A computing device for determining adaptive brightness for an image containing an animal, the computing device comprising:
at least one processor; and
a memory configured to store instructions executable by the at least one processor,
wherein the at least one processor is configured to:
acquire a first image containing the animal;
identify a first region corresponding to the animal in an entire region of the first image;
calculate a first brightness value in the first region; and
calculate the adaptive brightness of the first image on the basis of the first brightness value.
